(19) United States
(12) Patent Application Publication
(10) Pub. No.: US 2026/0193145 A1
(43) Pub. Date: Jul. 9, 2026

(54) METHOD FOR RECOVERING PHOSPHORUS, IRON, AND SULFUR ELEMENTS FROM FERROPHOSPHORUS SLAG WHILE CO-PRODUCING AMMONIUM PHOSPHATE FERTILIZER

(71) Applicant: Yunnan Minzu University, Kunming (CN)

(72) Inventors: Lijuan JIA, Kunming (CN); Rui CAO, Kunming (CN); Jiayu FENG, Kunming (CN); Shuo CUI, Kunming (CN); Zibin PAN, Kunming (CN); Lei SHI, Kunming (CN); Ping NING, Kunming (CN); Yonghui LI, Kunming (CN); Yanzhang LIU, Kunming (CN)

(21) Appl. No.: 19/444,577

(22) Filed: Jan. 9, 2026

(30) Foreign Application Priority Data
Jan. 9, 2025 (CN) 202510032847.6

(51) Int. Cl. C05B 7/00; B22F 9/20; C01B 17/06; C01B 25/28

(52) U.S. Cl. CPC C05B 7/00; B22F 9/20; C01B 17/06; C01B 25/28; B22F 2301/35

(57) ABSTRACT

This application provides a method for recovering phosphorus, iron, and sulfur elements from a ferrophosphorus slag while co-producing an ammonium phosphate fertilizer, including the following steps: (1) drying, grinding, and sieving the ferrophosphorus slag produced after lithium extraction to produce ferrophosphorus slag particles; (2) mixing the ferrophosphorus slag particles with an ammonium sulfide solution, conducting a hydrometallurgical reaction, and conducting separation to produce an ammonium phosphate solution, a ferrous sulfide solid, and an elemental sulfur solid; (3) subjecting the ammonium phosphate solution to vacuum evaporation for concentration, cooling crystallization, and drying to produce the ammonium phosphate fertilizer; (4) subjecting the ferrous sulfide solid to drying, high-temperature roasting, and purification to produce an iron powder; and (5) recovering the elemental sulfur solid for utilization. This application achieves the efficient separation and gradient recovery of phosphorus, iron, and sulfur elements from a ferrophosphorus slag while co-producing a high-value-added ammonium phosphate fertilizer.

### CROSS REFERENCE TO RELATED APPLICATION

This patent application claims the benefit and priority of Chinese Patent Application No. 2025100328476, filed with the China National Intellectual Property Administration on Jan. 9, 2025, the disclosure of which is incorporated by reference herein in its entirety as part of the present application.

### TECHNICAL FIELD

The present disclosure relates to the technical field of recycling of waste resources, and specifically relates to a method for recovering phosphorus, iron, and sulfur elements from a ferrophosphorus slag while co-producing an ammonium phosphate fertilizer.

### BACKGROUND

Under the backdrop of the carbon neutrality era, the new energy vehicle industry is developing rapidly. Lithium iron phosphate batteries have been widely used in new energy vehicles due to characteristics such as high thermal stability, long cycling life, and low cost. Lithium iron phosphate batteries typically have a service life of 3 years to 10 years. With the vigorous growth of the new energy vehicle sector, a surge in decommissioned power batteries is inevitable. According to statistics, cumulative decommissioned batteries in China are projected to reach as high as 125 GWh by 2025, with lithium iron phosphate batteries accounting for 50% or more. Consequently, if not properly managed, decommissioned lithium iron phosphate batteries pose a significant threat to the environment and result in the waste of valuable resources. After lithium iron phosphate is subjected to selective leaching and lithium recovery, a ferrophosphorus slag including substantial amounts of phosphorus and iron is generated. The ferrophosphorus slag includes ferric phosphate, carbon residue, and a small amount of impurities. The effective recovery of valuable components in the ferrophosphorus slag can reduce the dependence on primary mineral resources.

In addition to ferric phosphate (FePO₄) as a main component, the ferrophosphorus slag includes impurities such as graphite and lithium salts. Thus, the ferrophosphorus slag has a complex composition including components with much different physical and chemical properties, making the recycling of the ferrophosphorus slag quite challenging. Ferric phosphate in the ferrophosphorus slag is tightly bound to other iron-containing minerals. Moreover, ferrophosphorus slags mostly have high moisture and insoluble matter contents. As a result, it is difficult to efficiently separate valuable elements such as phosphorus and iron from a ferrophosphorus slag by a conventional physical or chemical recovery approach.

Currently, the main processes for recycling ferrophosphorus slags include hydrometallurgy, pyrometallurgy, integrated recovery, etc. However, these processes still exhibit varying degrees of limitations. The hydrometallurgy (including acid leaching and solvent extraction) is commonly used to recover elements including phosphorus and iron from a ferrophosphorus slag. However, the hydrometallurgy involves a complex reaction process, substantial consumption of acids and solvents, and a high cost. Additionally, the treatment of wastewater generated after acid leaching is challenging. The pyrometallurgy (such as high-temperature roasting) can effectively decompose ferric phosphate. However, due to the requirement of a high-temperature operation, the pyrometallurgy is not only energy-intensive, but may also generate a large amount of harmful gases, leading to considerable pollution. Some enterprises have attempted to directly convert a ferrophosphorus slag into a lithium iron phosphate material by an integrated recovery technology without generating intermediates of lithium carbonate and ferric phosphate. For example, some companies have successfully developed a process for directly converting a waste lithium iron phosphate material into a lithium iron phosphate material. Such a process can significantly enhance the resource utilization efficiency and avoid the challenges associated with handling intermediates. However, this technology is still in the exploratory phase and faces issues such as process instability and low product purity.

The patent CN117154273A proposes a method for recycling a spent cathode material of a lithium-ion battery, particularly a mixed black powder with high aluminum and iron contents. This method includes various steps including additive-assisted roasting, two-stage leaching, phosphate precipitation, co-precipitation, and phosphoric acid/phosphate regeneration. Through calcium salt-assisted roasting and phosphoric acid-based pH regulation, this method achieves the efficient recovery and recycling of valuable metals such as lithium, iron, aluminum, nickel, cobalt, and manganese and phosphorus. This method overcomes the challenges faced by conventional techniques in processing mixed cathode materials and residual aluminum. However, this method leads to by-products from various chemical reactions (for example, CaSO₄ and aluminate ions in a waste liquid). Additionally, whether this method is equally effective for other types of cathode materials (such as ternary materials or cathode materials with different doping systems) remains unclear. Thus, this method may exhibit limited adaptability, and requires additional adjustments to process conditions.

The patent CN115385314A discloses the following process: A ferrophosphorus slag is subjected to a thermal treatment with elemental carbon and a potassium-containing inorganic compound, such that iron ions are reduced into metallic iron by potassium and a phosphorus-potassium compound is generated to allow phosphorus recovery. Subsequently, solid-liquid separation and concentration are conducted to achieve the separation and extraction of iron and phosphorus. However, the thermal treatment in this process must be conducted under an inert atmosphere, which imposes high requirements on the sealing and atmosphere control of a device and may increase the initial investment and maintenance cost. The high-temperature thermal treatment and concentration processes may cause gas emissions or concentrated waste liquids, resulting in additional environmental concerns.

The patent CN118026126A discloses a process for producing ferric phosphate with a controllable specific surface area through leaching ferric phosphate with an acid, adjusting an iron-to-phosphorus ratio, adding ammonia water for precipitation to produce an intermediate including ferric ammonium phosphate, and roasting. The key of this process lies in regulating a precipitation stage with an ammonium salt to allow the effective control of a specific surface area of ferric phosphate. This process enables the controlled synthesis tailored to different types of spent lithium iron phosphate batteries. However, this process has relatively high requirements for an iron-to-phosphorus ratio and an impurity content in a spent ferrophosphorus slag. If a composition of a raw material fluctuates greatly, it can easily compromise the controllability of a quality and a specific surface area of a final ferric phosphate product.

The patent CN112331949A proposes a method for recovering phosphorus, iron, and lithium from a spent lithium iron phosphate battery. The method includes: soaking in an organic solvent to remove impurities in the spent lithium iron phosphate battery, aluminum removal with a sodium hydroxide solution, iron and phosphorus leaching with an acidic solution, and reactions with sulfuric acid and hydrogen peroxide to finally produce high-purity ferric phosphate and lithium carbonate products. This method can efficiently recover phosphorus, iron, and lithium from a spent battery, and can ensure that final products have a stable quality and meet the respective requirements for battery-grade ferric phosphate and lithium carbonate. This method involves the repeated use of chemical reagents such as a high-concentration acid solution and a sodium hydroxide solution, and requires high-temperature heating and long-time soaking. Although the generation of iron-containing slag and phosphorus-containing wastewater is avoided in this patent, there are no detailed explanations regarding the handling of other by-products and wastes.

The patent CN117460694A proposes a method for removing carbon impurities from a recovered ferrophosphorus slag and producing high-purity ferric phosphate accordingly. In this method, a magnetic field is applied to a ferrophosphorus slag dispersion to adsorb ferric phosphate, which enhances the floatability difference between ferric phosphate and carbon particles and facilitates the preliminary separation. The carbon particles are oxidized and activated with a strong oxidizing activator, and then further separated from the ferrophosphorus slag through a synergistic action of an aromatic ether, an inhibitor, and a collector. This series of treatments significantly improve the purity of ferric phosphate, which solves the problem that ferric phosphate produced from a ferrophosphorus slag during a spent battery recycling process has a high impurity content. However, this patent involves a multi-step process including magnetic separation, oxidation-activation with a strong oxidizing activator, and a synergistic action of an aromatic ether and an inhibitor. The aromatic ether and the collector may remain in a separated product. Consequently, in practical applications, a further optimized process may be required to address issues related to costs, environmental influence, and universality.

In summary, the current recycling processes for ferrophosphorus slags are not yet mature, allow low overall resource utilization levels, and are still faced with numerous challenges in economic viability and large-scale applications.

Therefore, developing a novel method for recycling a ferrophosphorus slag to achieve the efficient and high-value-added recovery of phosphorus, iron, and sulfur elements is an urgent issue to be addressed by those skilled in the art.

### SUMMARY

In view of this, an objective of the present disclosure is to provide a method for recovering phosphorus, iron, and sulfur elements from a ferrophosphorus slag while co-producing an ammonium phosphate fertilizer. The present disclosure aims to address issues such as low recovery efficiency and poor utilization efficiency of phosphorus, iron, and sulfur elements in a difficult-to-handle ferrophosphorus slag during a spent lithium iron phosphate battery recycling process in the prior art.

To achieve the above objective, the present disclosure adopts the following technical solutions:

A method for recovering phosphorus, iron, and sulfur elements from a ferrophosphorus slag while co-producing an ammonium phosphate fertilizer is provided, including the following steps:
(1) drying, grinding, and sieving the ferrophosphorus slag produced after lithium extraction to produce ferrophosphorus slag particles;
(2) mixing the ferrophosphorus slag particles with an ammonium sulfide solution, conducting a hydrometallurgical reaction, and conducting separation to produce an ammonium phosphate solution, a ferrous sulfide solid, and an elemental sulfur solid;
(3) subjecting the ammonium phosphate solution to vacuum evaporation for concentration, cooling crystallization, and drying to produce the ammonium phosphate fertilizer;
(4) subjecting the ferrous sulfide solid to drying, high-temperature roasting, and purification to produce an iron powder; and
(5) recovering the elemental sulfur solid for utilization.

Further, in the step (1), the drying is conducted in a drying oven at 100° C. to 150° C. for 4 h to 6 h to produce a material with a moisture content of 3% or less.

Additional beneficial effect of the above design: The drying is conducted to remove free water and bound water in the ferrophosphorus slag, which facilitates the subsequent grinding and hydrometallurgical reaction.

Further, in the step (1), the grinding is conducted with a ball mill; and the sieving includes vibratory sieving conducted to produce a material with a particle size of less than or equal to 8 mm.

Additional beneficial effect of the above design: The grinding and the sieving can increase a specific surface area of the material, thereby guaranteeing the uniform contact and reaction efficiency in the subsequent hydrometallurgical reaction.

Further, in the step (2), a mass concentration of the ammonium sulfide solution is 10% to 15%; and a mass ratio of the ferrophosphorus slag particles to the ammonium sulfide solution is 1:(3-8).

Further, in the step (2), the hydrometallurgical reaction is conducted in a sealed reactor at 60° C. to 80° C. under stirring for 1 h to 3 h.

Additional beneficial effect of the above design: During the hydrometallurgical reaction, ferric phosphate in the ferrophosphorus slag reacts with ammonium sulfide to produce the ammonium phosphate solution and the ferrous sulfide solid. A corresponding reaction equation is as follows:

$$6 {( N {H}_{4} )}_{2} S + 4 F e P {O}_{4} = 4 F e S ↓ + 4 {( N {H}_{4} )}_{3} P {O}_{4} + 2 S ↓ .$$

The ferrous sulfide (FeS) generated by the reaction settles at a bottom as a recovered product of iron. The ammonium phosphate ((NH₄)₃PO₄) is dissolved in an upper reaction solution to produce a raw material solution for a phosphate fertilizer. In this way, the efficient separation and recovery of iron, phosphorus, and sulfur are achieved.

Further, in the step (2), the separation is conducted by sedimentation or filtration.

Additional beneficial effect of the above design: Through the sedimentation or filtration, the ammonium phosphate solution is separated from the ferrous sulfide solid. The ammonium phosphate solution is further subjected to concentration and crystallization to produce the ammonium phosphate fertilizer.

Further, in the step (3), the vacuum evaporation for concentration is conducted in a vacuum evaporation device with a vacuum degree of 0.05 MPa to 0.1 MPa, an evaporation temperature of 50° C. to 70° C., and a concentration factor of 3 to 3.5 until the ammonium phosphate solution is concentrated to saturation.

Additional beneficial effect of the above design: Through the concentration and crystallization of the ammonium phosphate solution, a purity of the ammonium phosphate fertilizer reaches 98% or more, and a recovery rate of phosphorus reaches 97% or more. The ammonium phosphate fertilizer is suitable for agricultural crops.

Further, in the step (4), the high-temperature roasting is conducted in a high-temperature reduction roasting furnace with a CO/N₂ mixed gas as a reducing atmosphere, a heating rate of 10° C./min to 15° C./min, a heat-preservation temperature of 800° C. to 1,000° C., and a heat-preservation time of 30 min to 90 min.

Additional beneficial effect of the above design: Under the reducing atmosphere, the ferrous sulfide is converted into a metallic iron powder, which achieves the recovery and reuse of an iron resource. A corresponding reaction equation is as follows:

$$CO + F e S \to Fe + COS .$$

Further, in the step (4), the high-temperature roasting is conducted in a fluidized-bed roasting device with a H₂/N₂ mixed gas as a reducing atmosphere, a heat-preservation temperature of 800° C. to 1,000° C., and a heat-preservation time of 30 min to 90 min.

Further, in the step (4), the purification is conducted by magnetic separation.

Additional beneficial effect of the above design: The iron powder is further purified by magnetic separation or other physical methods for impurity removal to produce a high-purity iron powder with a purity of 98% or more. A recovery rate of iron is 94% or more.

According to the above technical solutions, compared with the prior art, the present disclosure has the following beneficial effects:
1. In the present disclosure, a ferrophosphorus slag generated during a spent lithium iron phosphate battery recycling process is selected as a raw material. Through steps such as drying, grinding, sieving, and hydrometallurgical reaction, phosphorus, iron, and sulfur elements in the ferrophosphorus slag are separated and recovered, which achieves the recycling. The ferrophosphorus slag is first dried, ground, and sieved, and then allowed to react with an ammonium sulfide solution to produce an ammonium phosphate solution, a ferrous sulfide solid, and an elemental sulfur solid. The ammonium phosphate solution is subjected to concentration and crystallization to produce a high-purity ammonium phosphate fertilizer, with a phosphorus recovery rate of 97% or more. The ferrous sulfide solid is subjected to high-temperature reduction roasting to produce a high-purity iron powder, with an iron recovery rate of 94% or more. The elemental sulfur is recovered as a by-product for utilization. After being further refined, the elemental sulfur can serve as a raw material for producing industrial sulfides or agricultural sulfur fertilizers, which reduces the solid waste emission. The present disclosure achieves the efficient separation and gradient recovery of phosphorus, iron, and sulfur elements from a ferrophosphorus slag while co-producing a high-value-added ammonium phosphate fertilizer. This method is concise, economical, and eco-friendly, making the method suitable for industrial scale-up. Thus, the present disclosure is of significant importance for facilitating the resource recycling in the spent lithium iron phosphate battery recycling industry.
2. In the present disclosure, through the combination of hydrometallurgical reaction-based separation with resource recovery and utilization, phosphorus, iron, and sulfur elements are effectively recovered from a ferrophosphorus slag, and an ammonium phosphate fertilizer is co-produced for utilization. The method of the present disclosure involves a short process flow, allows high resource utilization efficiency, and offers both economic benefits and environmental friendliness.
3. With the present disclosure, phosphorus and iron elements in a ferrophosphorus slag can be efficiently recovered. An ammonium phosphate fertilizer produced accordingly can be used in the agricultural sector. An iron resource is recycled in the form of an iron powder. Therefore, the present disclosure achieves the maximum resource utilization and the effective control of environmental pollution.

### DETAILED DESCRIPTION OF THE EMBODIMENTS

The technical solutions in the embodiments of the present disclosure are described clearly and completely below. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

### Example 1

A method for recovering phosphorus, iron, and sulfur elements from a ferrophosphorus slag while co-producing an ammonium phosphate fertilizer was provided, specifically including the following steps:
(1) The ferrophosphorus slag generated after lithium extraction was dried in a drying oven at 120° C. for 6 h until a moisture content was reduced to 3% or less, then ground with a ball mill, and sieved with a vibratory sieving device to produce ferrophosphorus slag particles with a particle size of 8 mm.
(2) The ferrophosphorus slag particles and an ammonium sulfide solution with a mass concentration of 10% were mixed at a mass ratio of 1:3, then placed in a sealed reactor, and stirred at 60° C. for 2 h to allow a reaction. Sedimentation was conducted for separation to produce an ammonium phosphate solution, a ferrous sulfide solid, and an elemental sulfur solid.
(3) The ammonium phosphate solution was placed in a vacuum evaporation device and subjected to vacuum evaporation at 0.05 MPa and 50° C. with a concentration factor of 3 until the ammonium phosphate solution was concentrated to saturation, then cooled to room temperature for crystallization, and dried to produce an ammonium phosphate fertilizer.
(4) The ferrous sulfide solid was first dried to produce a dried solid. The dried solid was then placed in a high-temperature reduction roasting furnace, and a CO/N₂ mixed gas was introduced. The dried solid was heated at a heating rate of 15° C./min from room temperature to 900° C. and kept at 900° C. for 60 min to allow high-temperature roasting. Magnetic separation was then conducted for purification to produce an iron powder.
(5) The elemental sulfur solid was recovered for utilization.

### Example 2

A method for recovering phosphorus, iron, and sulfur elements from a ferrophosphorus slag while co-producing an ammonium phosphate fertilizer was provided, specifically including the following steps:
(1) The ferrophosphorus slag generated after lithium extraction was dried in a drying oven at 150° C. for 5 h until a moisture content was reduced to 2% or less, then ground with a ball mill, and sieved with a vibratory sieving device to produce ferrophosphorus slag particles with a particle size of 5 mm.
(2) The ferrophosphorus slag particles and an ammonium sulfide solution with a mass concentration of 10% were mixed at a mass ratio of 1:4, then placed in a sealed reactor, and stirred at 70° C. for 3 h to allow a reaction. Sedimentation was conducted for separation to produce an ammonium phosphate solution, a ferrous sulfide solid, and an elemental sulfur solid.
(3) The ammonium phosphate solution was placed in a vacuum evaporation device and subjected to vacuum evaporation at 0.08 MPa and 60° C. with a concentration factor of 3.5 until the ammonium phosphate solution was concentrated to saturation, then cooled to room temperature for crystallization, and dried to produce an ammonium phosphate fertilizer.
(4) The ferrous sulfide solid was first dried to produce a dried solid. The dried solid was then placed in a high-temperature reduction roasting furnace, and a CO/N₂ mixed gas was introduced. The dried solid was heated at a heating rate of 10° C./min from room temperature to 950° C. and kept at 950° C. for 90 min to allow high-temperature roasting. Magnetic separation was then conducted for purification to produce an iron powder.
(5) The elemental sulfur solid was recovered for utilization.

### Example 3

A method for recovering phosphorus, iron, and sulfur elements from a ferrophosphorus slag while co-producing an ammonium phosphate fertilizer was provided, specifically including the following steps:
(1) The ferrophosphorus slag generated after lithium extraction was dried in a drying oven at 130° C. for 4 h until a moisture content was reduced to 3% or less, then ground with a ball mill, and sieved with a vibratory sieving device to produce ferrophosphorus slag particles with a particle size of 3 mm to 5 mm.
(2) The ferrophosphorus slag particles and an ammonium sulfide solution with a mass concentration of 15% were mixed at a mass ratio of 1:3.5, then placed in a sealed reactor, and stirred at 60° C. to 80° C. for 1 h to 3 h to allow a reaction. Sedimentation or filtration was conducted for separation to produce an ammonium phosphate solution, a ferrous sulfide solid, and an elemental sulfur solid.
(3) The ammonium phosphate solution was placed in a vacuum evaporation device and subjected to vacuum evaporation at 0.08 MPa and 55° C. with a concentration factor of 3 until the ammonium phosphate solution was concentrated to saturation, then cooled to room temperature for crystallization, and dried to produce an ammonium phosphate fertilizer.
(4) The ferrous sulfide solid was first dried to produce a dried solid. The dried solid was then placed in a fluidized-bed roasting device, and a H₂/N₂ mixed gas was introduced. The dried solid was heated at a heating rate of 15° C./min from room temperature to 1,000° C. and kept at 1,000° C. for 80 min to allow high-temperature roasting. Magnetic separation was then conducted for purification to produce an iron powder.
(5) The elemental sulfur solid was recovered for utilization.

### Performance Testing

With ferrophosphorus slags generated during processing of a spent lithium iron phosphate battery recycling plant in China as raw materials, phosphorus, iron, and sulfur elements were recovered and an ammonium phosphate fertilizer was co-produced according to the methods in Examples 1 to 3.

Main components in the ferrophosphorus slags of Examples 1 to 3 and contents (mass fractions) thereof were determined separately. A purity of an ammonium phosphate fertilizer, a recovery rate of phosphorus, a purity of an iron powder, and a recovery rate of iron were calculated. Results were shown in Table 1.

TABLE 1
Performance test results of recovered phosphorus, iron, and sulfur elements and
co-produced ammonium phosphate fertilizers from the ferrophosphorus slags in Examples 1 to 3.

| | | Purity of an | | | |
|---|---|---|---|---|---|
| | Main components in a | ammonium | Recovery rate | Purity of | |
| | ferrophosphorus slag | phosphate | of | an iron | Recovery |
| Example | and contents thereof | fertilizer | phosphorus | powder | rate of iron |
| 1 | 35.12% of Fe, 19.03% | 99.2% | 97.8% | 98.5% | 95.7% |
| | of P, 38.85% of H₂O, | | | | |
| | and 0.10% of Li | | | | |
| 2 | 34.80% of Fe, 19.15% | 98.9% | 97.2% | 98.8% | 94.5% |
| | of P, 40.10% of H₂O, | | | | |
| | and a small amount of | | | | |
| | impurities | | | | |
| 3 | 35.50% of Fe, 18.70% | 99.0% | 98.0% | 99.0% | 96.3% |
| | of P, and 39.20% of H₂O | | | | |

As shown in Table 1, in Examples 1 to 3, a purity of an ammonium phosphate fertilizer, a recovery rate of phosphorus, a purity of an iron powder, and a recovery rate of iron all remain at relatively high levels.

According to the above tests, the present disclosure achieves the efficient separation and gradient recovery of phosphorus, iron, and sulfur elements from a ferrophosphorus slag while co-producing a high-value-added ammonium phosphate fertilizer. This method is concise, economical, and eco-friendly, making the method suitable for industrial scale-up. Thus, the present disclosure is of significant importance for facilitating the resource recycling in the spent lithium iron phosphate battery recycling industry.

The above description of the disclosed embodiments enables those skilled in the art to implement or utilize the present disclosure. Various modifications to these embodiments are readily apparent to those skilled in the art, and the general principles defined herein may be practiced in other embodiments without departing from the spirit or scope of the present disclosure. Thus, the present disclosure is not limited to the embodiments shown herein, but falls within the widest scope consistent with the principles and novel features disclosed herein.

What is claimed is:

1. A method for recovering phosphorus, iron, and sulfur elements from a ferrophosphorus slag while co-producing an ammonium phosphate fertilizer, comprising following steps:
(1) drying, grinding, and sieving the ferrophosphorus slag produced after lithium extraction to produce ferrophosphorus slag particles;
(2) mixing the ferrophosphorus slag particles with an ammonium sulfide solution, conducting a hydrometallurgical reaction, and conducting separation to produce an ammonium phosphate solution, a ferrous sulfide solid, and an elemental sulfur solid;
(3) subjecting the ammonium phosphate solution to vacuum evaporation for concentration, cooling crystallization, and drying to produce the ammonium phosphate fertilizer;
(4) subjecting the ferrous sulfide solid to drying, high-temperature roasting, and purification to produce an iron powder; and
(5) recovering the elemental sulfur solid for utilization.

2. The method for recovering phosphorus, iron, and sulfur elements from a ferrophosphorus slag while co-producing an ammonium phosphate fertilizer according to claim 1, wherein in the step (1), the drying is conducted in a drying oven at 100° C. to 150° C. for 4 h to 6 h to produce a material with a moisture content of 3% or less.

3. The method for recovering phosphorus, iron, and sulfur elements from a ferrophosphorus slag while co-producing an ammonium phosphate fertilizer according to claim 1, wherein in the step (1), the grinding is conducted with a ball mill; and the sieving comprises vibratory sieving conducted to produce a material with a particle size of less than or equal to 8 mm.

4. The method for recovering phosphorus, iron, and sulfur elements from a ferrophosphorus slag while co-producing an ammonium phosphate fertilizer according to claim 1, wherein in the step (2), a mass concentration of the ammonium sulfide solution is 10% to 15%; and a mass ratio of the ferrophosphorus slag particles to the ammonium sulfide solution is 1:(3-8).

5. The method for recovering phosphorus, iron, and sulfur elements from a ferrophosphorus slag while co-producing an ammonium phosphate fertilizer according to claim 1, wherein in the step (2), the hydrometallurgical reaction is conducted in a sealed reactor at 60° C. to 80° C. under stirring for 1 h to 3 h.

6. The method for recovering phosphorus, iron, and sulfur elements from a ferrophosphorus slag while co-producing an ammonium phosphate fertilizer according to claim 1, wherein in the step (2), the separation is conducted by sedimentation or filtration.

7. The method for recovering phosphorus, iron, and sulfur elements from a ferrophosphorus slag while co-producing an ammonium phosphate fertilizer according to claim 1, wherein in the step (3), the vacuum evaporation for concentration is conducted in a vacuum evaporation device with a vacuum degree of 0.05 MPa to 0.1 MPa, an evaporation temperature of 50° C. to 70° C., and a concentration factor of 3 to 3.5 until the ammonium phosphate solution is concentrated to saturation.

8. The method for recovering phosphorus, iron, and sulfur elements from a ferrophosphorus slag while co-producing an ammonium phosphate fertilizer according to claim 1, wherein in the step (4), the high-temperature roasting is conducted in a high-temperature reduction roasting furnace with a CO/N₂ mixed gas as a reducing atmosphere, a heating rate of 10° C./min to 15° C./min, a heat-preservation temperature of 800° C. to 1,000° C., and a heat-preservation time of 30 min to 90 min.

9. The method for recovering phosphorus, iron, and sulfur elements from a ferrophosphorus slag while co-producing an ammonium phosphate fertilizer according to claim 1, wherein in the step (4), the high-temperature roasting is conducted in a fluidized-bed roasting device with a H₂/N₂ mixed gas as a reducing atmosphere, a heat-preservation temperature of 800° C. to 1,000° C., and a heat-preservation time of 30 min to 90 min.

10. The method for recovering phosphorus, iron, and sulfur elements from a ferrophosphorus slag while co-producing an ammonium phosphate fertilizer according to claim 1, wherein in the step (4), the purification is conducted by magnetic separation.
